(19) United States
(12) Patent Application Publication
(10) Pub. No.: US 2020/0071217 A1
(43) Pub. Date: Mar. 5, 2020

(54) APPARATUS FOR CONVERTING A SEPTIC TANK INTO AN AEROBIC TREATMENT SYSTEM AND A WASTEWATER TREATMENT SYSTEM EMPLOYING SUCH APPARATUS

(71) Applicants: T. Gig DREWERY, Longview, TX (US); Trina V. DREWERY, Longview, TX (US)

(72) Inventors: T. Gig DREWERY, Longview, TX (US); Trina V. DREWERY, Longview, TX (US)

(21) Appl. No.: 16/551,005

(22) Filed: Aug. 26, 2019

Related U.S. Application Data
(60) Provisional application No. 62/723,863, filed on Aug. 28, 2018.

(51) Int. Cl. C02F 9/00; C02F 3/12; C02F 11/04; C02F 3/30

(52) U.S. Cl. CPC C02F 9/005; C02F 3/1242; C02F 1/002; C02F 3/30; C02F 11/04

(57) ABSTRACT

An apparatus for converting the septic tank into an aerobic treatment system has a clarifier with a collapsible wall which allows the clarifier to fold in order to pass through the opening of the septic tank and to unfold upon entry into the septic tank, an aerator having a size suitable for passing through the opening of the septic tank in position between the wall of the clarifier and a wall of the septic tank, and an air pump connected to the aerator so as to pass air to the aerator. The clarifier has an opening at a bottom thereof having a diameter no greater than a diameter of the top of the clarifier. The effluent outlet pipe is received in an aperture formed in a wall of the clarifier.

### CROSS-REFERENCE TO RELATED APPLICATIONS

The present application claims priority from U.S. Provisional Patent Application Ser. No. 62/723,863, filed Aug. 28, 2018 and entitled “Septic Tank Settling Device or Collapsible Clarifier”

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to wastewater treatment. More particularly, the present invention relates to septic tanks with aeration capability. More particularly, the present invention relates to collapsible or compressible clarifiers that can be placed through the opening of the septic tank.

### 2. Description of Related Art Including Information Disclosed Under 37 CFR 1.97 and 37 CFR 1.98

Septic tank and drainfield systems have a history of failure problems. Although the systems have been used for years and are still a preferred method for treating and dispersing domestic wastewater from homes and small commercial establishments, such septic tank and drain field systems have inherent problems and also pollute the environment.

One problem is that treatment in the septic tank is minimal. The septic tank utilizes anaerobic bacteria to carry out the treatment. This anaerobic bacteria is bacteria that does not use oxygen and is consequently very slow at treating the wastewater. Consequently, when the wastewater leaves the septic tank toward the drainfield, the wastewater is poorly treated. The effluent from the septic tank is high in total suspended solids and high in biological oxygen demand. This places a high treatment demand on the drainfield before the effluent is dispersed through the soil interface of the drainfield and into the surrounding soil and onto the ground water. In fact, it is the soil interface where the final treatment of the septic effluent occurs. The soil interface of the drainfield is generally described as the bottom and inside walls of the drainfield. The same anaerobic bacteria utilized in the septic tank is responsible for the final treatment at the soil interface in the drainfield. This anaerobic treatment process forms a sludge biomat at the soil interface. In other words, the bacteria uses the soil interface as a media to grow on. As the effluent passes through the biomat, the final treatment occurs and the biomat grows or enlarges.

From a management perspective, this anaerobic treatment process is inadequate. The very treatment process that provides final treatment of the effluent will plug the soil interface. As the biomat grows, more and more soil becomes plugged. When enough soil of the drainfield is plugged, the remaining soil is inadequate to treat and disperse the effluent from the septic tank. As a result, the septic tank and the drainfield start to fail. The failure starts with short periods of high-level conditions in the septic tank which can affect the proper use of the facilities in the home. The failure can also start with inadequately treated effluent surfacing at the drainfield area. Both of these conditions can occur simultaneously. If left unattended, complete failure is imminent. During this condition, the environment is being polluted. Studies have been conducted which reveal groundwater and well water contamination without the aforementions signs of failiure.

In the past, septic tank and drainfield failure has been somewhat accepted. Septic tank and drainfield replacement has been the only solution.

Experiments and testing have shown that aerobic system effluent can be a much higher quality effluent, much lower in total suspended solids and much lower in biological oxygen demand. Therefore, the drainfield has to do much less treatment. The aerobic system is also high in dissolved oxygen and has high levels of aerobic bacteria. Not only does the aerobic system effluent protect the drainfield from further plugging, it starts to reverse the drainfield plugging that has already occurred. No longer does the drainfield operate in the anaerobic mode (void of oxygen), but it operates in a high dissolved oxygen state. It is this high dissolved oxygen in the presence of high levels of aerobic bacteria that destroys the anaerobic biomass and consumes it. As this occurs, the soil interface becomes unplugged and proper drainfield functions are restored.

Due to these findings, septic tank conversion products can convert already installed septic tanks into aerobic treatment systems. For example, U.S. Pat. No. 5,162,083, issued on Nov. 10, 1992 to Forbes et al., describes a method and apparatus for converting a standard anaerobic septic tank system to an aerobic system where the effluent discharged at a high level of quality sufficient to meet or exceed all national and state standards. The method provides a series of steps that are used to convert a pre-existing anaerobic septic tank to a highly efficient aerobic system. The system includes an aerator and a clarifier insert which has the capability of adding an optional chlorine chamber which dispenses chlorine into the effluent line in its final stages. The system requires building a new lid and attaching a clarifier and diffuser drops to the lid. The lid and the attached clarifier and diffuser are dropped and lowered into the septic tank and attached to the septic tank. This method requires excavation and hoisting equipment. This is costly and can cause damage to the finished yard landscaping.

U.S. Pat. No. 6,554,996, issued on Apr. 29, 2003 to R. J. Radori, describes a wastewater treatment system and apparatus for converting a typical anaerobic septic tank system into an efficient aerobic treatment system for treating a liquor containing biodegradable wastes. The apparatus includes a collapsible reactor module that can pass through a relatively small opening in the septic tank cover. The reactor module contains media therein in which the liquor to be treated is recirculated and aerated. The reactor module is full of fixed film media. Although this device does away with the costly excavation and hoisting procedures, the product itself is costly due to the nature of the fixed film media systems.

As septic tank drainfield systems continue to fail, a more cost-effective septic tank conversion method is required. U.S. Pat. No. 7,718,067, issued on May 18, 2010 to K. K. Holt, teaches a method and apparatus for mediating a failed or failing wastewater treatment system. This method includes a positive air generating pressure pump directing air through a tube to an air stone suspended in the effluent. Attached growth bacteria grow on a plurality of random directional brushes in an effluent tank, e.g. a septic tank. This method allows for installation of the equipment through an opening in the septic tank lid and avoids expensive excavating and hoisting. It also prevents finished landscape destruction. Also, the cost is much less than fixed film media aerobic systems. The method of the Holt patent places a diffuser or aerator directly into the septic tank. Air is introduced through the diffuser and causes the contents of the septic tank to be mixed. As the contents are mixed together, dissolved oxygen is transferred into the solution. The septic tank is converted from an anaerobic environment to an aerobic environment. Aerobic bacteria begin to multiply and form suspended solids within the septic tank. As the aerobic bacteria colony grows or multiplies, so do the suspended solids within the septic tank. Although this process gives the septic tank the ability to aerobically treat the household waste, it simultaneously creates a problem in that the suspended solids carry out of the septic tank to the drainfield into the environment. These suspended solids are mostly made up of partially metabolized or digested wastes and consequently cause damage to the drainfield and the environment.

The present inventor is the inventor identified in several patents associated with aerobic wastewater treatment systems. For example, U.S. Pat. No. 5,266,239, issued on Nov. 30, 1993 to the present inventor, describes a diffuser assembly for an aeration system of a wastewater treatment plant. This aeration apparatus has an air line connected to an air source, a drop line connected in fluid communication with the air line, a check valve positioned in the drop line between an orifice at the bottom of the drop line and the air line, and a diffuser member extending around the orifice on the drop line. The check valve serves to prevent liquid from passing therethrough. The drop line includes a tube which extends downwardly from the air line.

U.S. Pat. No. 6,096,203, issued on Aug. 1, 2000 to the present inventor, teaches a wastewater treatment system having a tank with an inlet and an outlet and an offset access opening residing at the top of the tank. A clarifier compartment is positioned within the tank. An aeration compartment is formed within the tank around the exterior of the clarifier compartment. Aerators extend into the aeration compartment so as to supply air to the wastewater within the aeration compartment. The access opening is formed between a center of the top and outer wall of the tank. Each of the aerators includes an air inlet, a conduit connected to the air inlet, a diffuser assembly connected to an end of the conduit opposite the air inlet, and an anchor connected to the diffuser assembly opposite the conduit so as to maintain the diffuser in a fixed position within the aeration compartment.

U.S. Pat. No. 6,165,359, issued on Dec. 26, 2000 to the present inventor, shows a high-strength wastewater treatment system having a first tank with an inlet and an outlet, an aerator positioned within the first tank for passing oxygen into the wastewater within the first tank, a second tank having a clarifier compartment positioned therein, an aeration device positioned in the second tank for passing oxygen into a liquid within the second tank, and a pipe connected the first tank and the second tank for passing liquid from the second tank to the first tank. The pipe has an end opening within the second tank and a diffuser connected to the pipe within the first tank. The diffuser is a venturi diffuser. An air pump is connected to the venturi diffuser for injecting air into the narrow section of the diffuser. This delivery of air serves to draw liquid from the second tank through the pipe and into the first tank.

U.S. Pat. No. 6,254,066, issued on Jul. 3, 2001 to the present inventor, provides an apparatus for aerating liquid in a wastewater treatment tank. The apparatus has a submergable motor with a shaft extending outwardly therefrom, a supporting member affixed to the submergable motor and adapted to maintain the submergable the motor in a position within the liquid in the wastewater treatment tank. A propeller is affixed to the shaft of the submergable motor. A housing extends around the propeller and the shaft. An air tube is connected to the housing and is adapted to pass air interior of the housing between the propeller and the motor.

It is an object of the present invention to provide a process and apparatus for producing clear odorless effluent from a septic tank.

It is another object of the present invention to provide a process and apparatus which avoids the clogging and failure of the drainfield.

It is another object of the present invention to provide an apparatus and system which reverses damage to an already exhausted drainfield.

It is another object of the present invention to provide an apparatus and system which aerates the waste in the septic tank.

It is another object of the present invention to provide a system and apparatus which is easy to retrofit into existing septic tanks.

It is another object of the present invention to provide a system and apparatus which reduces product cost.

It is a further object of the present invention to provide a system and apparatus which avoids excavations and damage to lawns and landscape.

It is a further object of the present invention to provide an apparatus and system that has minimal installation costs.

It is a further object of the present invention to provide an apparatus and system that improves environmental quality.

These and other objects and advantages of the present invention will become apparent from a reading of the attached specification and appended claims.

### BRIEF SUMMARY OF THE INVENTION

The present invention is an apparatus for converting a septic tank into an aerobic treatment system for treating liquor containing biodegradable wastes. The septic tank has an opening at the top thereof. The septic tank also has a water inlet pipe and an effluent outlet pipe.

The apparatus of the present invention includes a clarifier having a collapsible or compressible wall which allows the clarifier to fold in order to pass through the opening of the septic tank and to unfold upon entry into the septic tank. The clarifier has an opening at the top thereof and an opening at a bottom thereof. The opening at the bottom has a diameter no greater than a diameter of the opening at the top of the clarifier. The present invention also has an aerator having a size suitable for passing into the opening of the septic tank. The aerator is adapted to be positioned between the wall of the clarifier and a wall of the septic tank so as to form an aeration chamber within the septic tank. An air pump is connected to the aerator so as to pass air to the aerator.

The clarifier has an aperture formed in the wall thereof. This aperture receives the effluent outlet pipe therein such that the effluent outlet pipe opens to an interior of the clarifier. The wall of the clarifier is spaced from the end of the wastewater inlet pipe.

The liquor in the septic tank has a top surface. The clarifier is positionable such that the top of the clarifier resides above the top surface of the liquor. The bottom of the clarifier is positioned below the top surface of the liquor.

The clarifier has at least one float connected thereto. The float causes the clarifier to float in the liquor within the septic tank. This float includes a plurality of floats arranged in spaced relation to each other around the clarifier. The float is affixed to the wall of the clarifier such that a portion of the float is exposed in an inner or outer wall of the clarifier. The clarifier, in the preferred embodiment, has a truncated conical configuration.

The present invention utilizes a collapsible or compressible settling chamber or clarifier. While in the collapsed position, the clarifier is inserted into the septic tank through an opening in the lid of the septic tank. Once inside the tank, the clarifier is opened to its original size. The clarifier has a continuous vertical or diagonal wall forming the settling chamber. The settling chamber is open at the top and the bottom. The top of the clarifier is positioned above the flow line of the septic tank while the bottom of the clarifier is positioned off the bottom of the septic tank. An outlet hole is formed in the top side of the clarifier at the flow line and this outlet hole is connected to the outlet pipe of the septic tank. One or more diffusers are positioned at the bottom of the septic tank between the septic tank and the wall of the clarifier. Air is provided to the diffuser or diffusers by remotely-located air pump.

Once the air pump is actuated, mixing of the contents of the septic tank begin. Not only does the diffuser or diffusers mix the contents, but they dissolved oxygen into the solution within the septic tank. Once domestic waste full of bacteria enters the septic tank, it is mixed with the high dissolved oxygen content such that the bacteria will then start to grow and flourish. Suspended solids (i.e. partially metabolized bacteria-rich waste) start to form. These suspended solids or mixed liquor is what will treat the waste and inevitability produce a clear odorless effluent from the septic tank. As wastewater enters the septic tank, it is mixed with the already present mixed liquor and is metabolized by the bacteria. Hydraulic displacement causes the suspended solids to enter the bottom of the clarifier. Due to the calm quiescent condition within the clarifier, the solids settle out of the clarifier and return to the aerated septic tank for further treatment. The solids also reseed the septic tank with bacteria. The clear odorless effluent remaining will leave the septic tank and be delivered toward the drainfield. The problem of suspended solids passing out of the septic tank to the drainfield and into the environment is solved. Actually, the aerobic treatment ability of the septic tank is further is enhanced due to the reseeding of the bacteria when the suspended solids return to the septic tank. All of this occurs while maintaining the product's ability to be installed through an opening in the septic tank and to keep the product cost low.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a cross-sectional view showing the wastewater treatment system of the present invention.

FIG. 2 is a cross-sectional plan view showing the interior of the wastewater treatment system of the present invention.

FIG. 3 is a transparent top view of the wastewater treatment system of the present invention.

FIG. 4 is a plan view of the foldable or compressible clarifier as used in the present invention.

FIG. 5 is a side elevational view of the foldable or compressible clarifier as used in the system of the present invention.

### DETAILED DESCRIPTION OF THE INVENTION

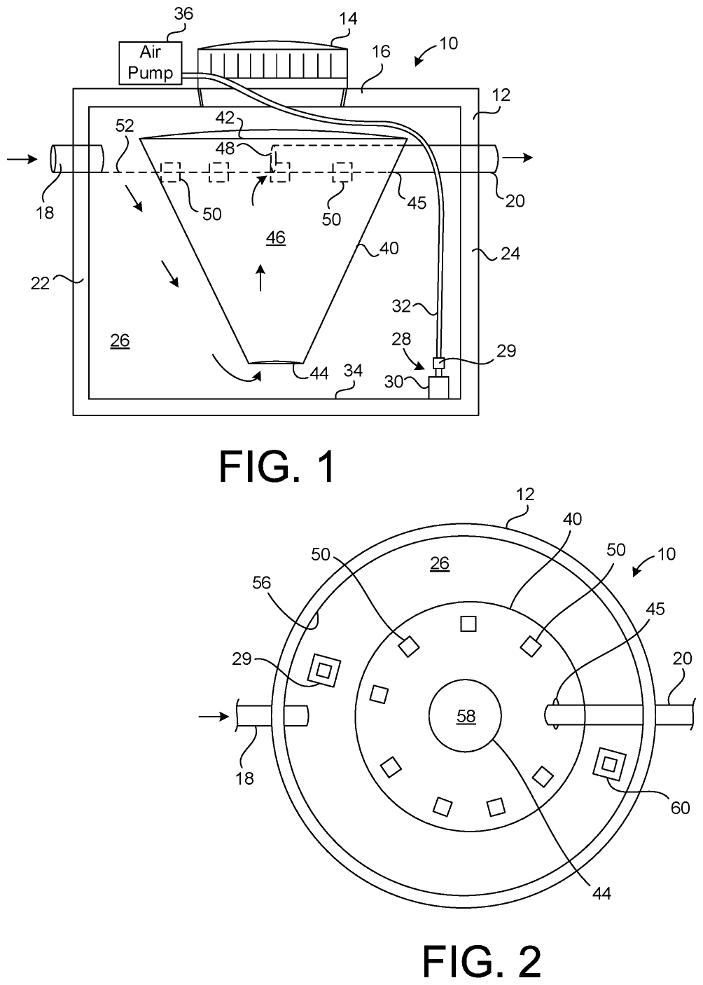

Referring to FIG. 1, there shown the wastewater treatment system 10 in accordance with teachings of the present invention. The wastewater treatment system 10 includes a septic tank 12 having an opening 14 at the top wall 16 thereof. The septic tank 12 has a wastewater inlet pipe 18 and an effluent outlet pipe 20. Wastewater inlet pipe 18 extends through a sidewall 22 of the septic tank 12. The effluent outlet pipe 20 extends through another wall 24 as indicated by the arrows, the wastewater will enter the interior volume 26 of the septic tank 12 through the wastewater inlet pipe 18.

In FIG. 1, it can be seen that there is an aerator 28 positioned within the interior volume 26 of the septic tank 12. Aerator 28 includes a porous ceramic a diffuser 29 having a tube 32 connected thereto. An anchor 30 is connected to a bottom of diffuser 29. Anchor 30 will reside at the bottom 34 of the septic tank 12. The tube 32 will extend from the diffuser 29 upwardly through the septic tank 12 and ultimately outwardly through the opening 14 of the septic tank. An air pump 36 is positioned exterior of the interior volume 26 of the septic tank 12. The tube 32 is connected to the air pump 36. Air pump 36 can be connected to a suitable supply of electricity and operated so as to pump air through the tube 32 and ultimately to the diffuser 29.

A clarifier 40 having collapsible walls is placed in the interior volume 26 of the septic tank 12. Importantly, since the clarifier 40 has foldable or compressible walls, the clarifier 40 can be passed through the opening 14 at the top 16 of the septic tank 12. Once the folded clarifier 40 has been passed into the interior volume 26 of the septic tank 12 in an area below the top 16, the clarifier 40 is unfolded so as to return to its original configuration. The clarifier 40 has an opening at a top 42 thereof and an opening at a bottom 44 thereof. The diameter of the opening at the bottom 44 should be no greater than the diameter of the opening at the top 42. As such, as shown in FIG. 1, the clarifier 40 has a truncated conical shape. However, experiments conducted with the present invention have indicated that the clarifier 40 will work properly if the sidewalls of the clarifier form a cylindrical shape rather than a tapered truncated conical shape. This is a surprising result since clarifiers of the prior art have all had a truncated conical configuration.

The walls of the clarifier 40 can be made foldable or compressible by being formed of a relatively thin polymeric material. Alternatively, the various sections of the clarifier 40 can be hinged together so as to allow the walls to fold one upon the other. Still in other circumstances, the clarifier 40 is flexible enough to be simply squeezed or compressed so as to fit through the opening 14.

The clarifier 40 has an aperture 45 formed on a wall thereof. The effluent outlet pipe 20 will extend through this aperture 45 and into the interior volume 46 of the clarifier 40. As such, the end 48 of the effluent outlet pipe 20 will reside within the clarifier 40. A plurality of floats 50 are affixed to the wall of the clarifier 40 so as to cause the clarifier 42 to float at the top surface 52 of the liquor within the septic tank 12. The top 42 of the clarifier 40 will be located above this top surface 52. The bottom 44 of the clarifier 40 is located below this top surface 52.

The clarifier 40 creates a clarifying or settling chamber within the interior volume 26 of the septic tank 12. The aerator 28, along with the air pump 36, serve to create an aeration compartment within the septic tank 12.

This aeration compartment within the interior of the septic tank 12 receives the raw wastewater by way of the wastewater inlet 18. It is in this aeration compartment that the raw wastewater is mixed with the activated sludge and is aerated by way of the aerator 28. As the raw wastewater is mixed with oxygen in this aeration compartment, the aerobic bacteria uses the oxygen in solution so as to break down the wastewater and convert it to an odorless liquid and gas. As this aeration compartment comes full, hydraulic displacement will cause the mixture to enter the clarifier 40 through the opening at the bottom 44. This flow path is indicated by the arrows in FIG. 1. The opening at the bottom 44 of the clarifier 40 allows remaining settleable material to return to the aeration compartment portion of the septic tank 12 for further treatment. When the remaining effluent fills the clarifier 40, it will reach the effluent outlet pipe 20 so as to be discharged from the septic tank.

The air pump 36 is suitable for causing compressed air to pass through the tube 32 into the interior of the septic tank 12. Air is then passed from the tube 32 toward the diffuser 29. The diffuser 29 is positioned adjacent to the bottom of the septic tank 12. Diffuser 29 is a porous ceramic diffuser. This diffuser creates thousands of tiny air bubbles which provide oxygen for the aerobic digestion process and serves to mix the entire contents of the septic tank 12.

Once the wastewater full of bacteria enters the septic tank 12 and is mixed with dissolved oxygen, the bacteria starts to grow and flourish. Suspended solids (i.e. partially metabolized bacteria-rich waste) start to form. These suspended solids or mixed liquor is what will treat the wastewater and inevitably produce a clear odorless effluent from the septic tank 12. As the wastewater enters the septic tank through the wastewater inlet 18, it is mixed with the already present mixed liquor and is metabolized by the bacteria. Hydraulic displacement causes the suspended solids to enter the bottom of the clarifier 40. Due to the calm quiescent condition within the clarifier 40, the solids settle out of the clarifier 40 and return to the interior volume 26 for further treatment and to further reseed the septic tank with bacteria. The clear odorless effluent remaining will leave the septic tank through the effluent outlet 20 and is delivered toward the drainfield. The problem of suspended solids carrying out of the septic tank 12 to the drainfield and the environment is solved. The aerated treatment ability of the septic tank 12 is enhanced further due to the receipt of the bacteria when the suspended solids return to the interior volume 26 of the septic tank.

FIG. 2 shows a top view of the wastewater treatment system 10 of the present invention. In FIG. 2, it can be seen that the septic tank 12 has a generally circular configuration. It is important to note that the present invention can be used effectively with septic tanks having other shapes and other sizes. The clarifier 40 has been placed through the opening and now is open and is in the original configuration within the interior volume 26 of the septic tank 12. A plurality of floats 50 are affixed to the clarifier 40 so as to allow the clarifier 40 to float at the top surface of the liquor within the septic tank 12. The wastewater inlet pipe 18 extends through the wall of the septic tank 12 so as to open to the space between the clarifier 40 and the inner wall 56 of the septic tank 12. Ultimately, this wastewater will flow downwardly so as to ultimately enter the opening 58 at the bottom 44 of the clarifier 40. As treated wastewater moves upwardly in the clarifier 40, it can ultimately be delivered to the drainfield by way of the effluent outlet pipe 20. The effluent outlet pipe 20 is received through an aperture 45 in the wall of the clarifier 40. FIG. 2 also shows that there are diffusers 29 and 60 placed on opposite sides of the clarifier 40 for the purpose of aerating the liquor within the septic tank 12, as described hereinbefore.

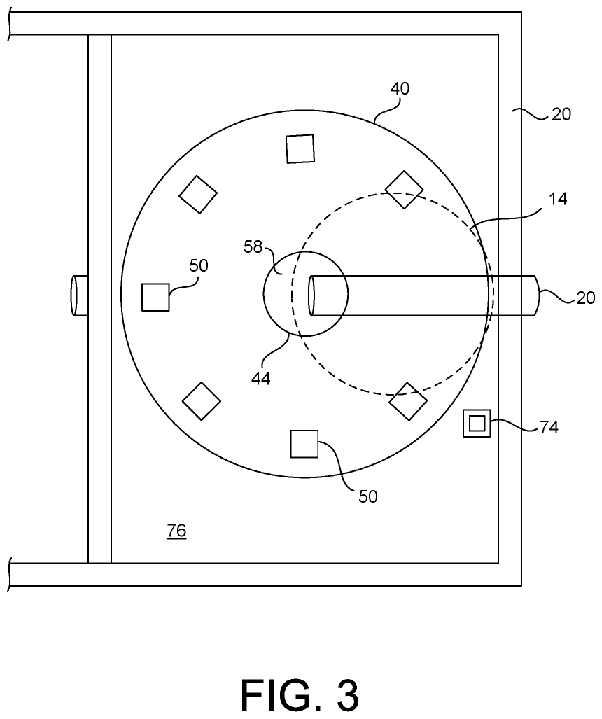

FIG. 3 is a plan view of a square-shaped septic tank 70. The septic tank 70 has the clarifier 40 positioned on an interior thereof. The opening 14 of the septic tank 70 is shown in broken line fashion in FIG. 3. The clarifier 40 should have suitably collapsible, compressible or foldable walls so that the clarifier 40 can pass through the opening 14 at the top of the septic tank 70 and then unfold on the interior of the septic tank. The effluent outlet pipe 20 extends so as to have its end positioned generally over the clarifier 40 and above the opening 58 at the bottom 44 of clarifier 40. A plurality of floats 50 are arranged in spaced relationship along the inner or outer walls of clarifier 40. These floats 50 can have a portion extending into the interior volume of the clarifier 40. FIG. 3 shows that there is an aerator or diffuser 74 positioned in the interior volume 76 of the septic tank 70 on the exterior of the clarifier 40.

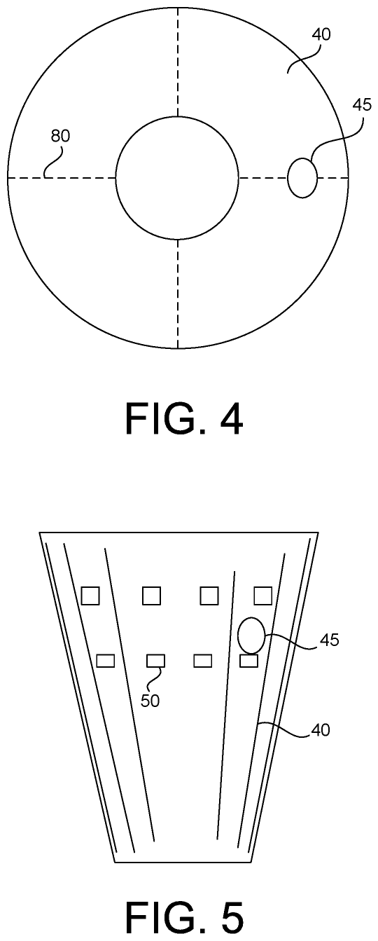

FIG. 4 is a plan view of the clarifier 40. In FIG. 4, it can be seen that the aperture 45 opens through a wall of the clarifier 40. Broken line areas 80 illustrate seams, perforations, slots, hinges, or other configurations which allow the clarifier to suitably fold or compress for insertion into the opening 14 of the septic tank.

FIG. 5 is a side view of the clarifier 40. FIG. 5 shows that the floats 50 are arranged generally in the area adjacent to the bottom of the aperture 45. As such, the top surface or water line of the liquor within the septic tank will be generally adjacent to where the effluent outlet pipe 20 resides. The clarifier 40 is illustrated in FIG. 5 as having a truncated conical configuration. However, it is important to note that the cylindrical configuration will work properly with the present invention. Importantly, the clarifier 40 can be installed through a top opening of the septic tank. No excavating or damage to property adjacent to the septic tank is necessary.

Within the concept of the present invention, there is provided a clarifier which is collapsible, foldable or compressible so as to allow the clarifier to be received into the interior of the septic tank. Once inside the septic tank, the clarifier will float in a proper position after being installed on the effluent outlet pipe. Importantly, in the present invention, it is also possible to support the clarifier with brackets attached to the bottom of the clarifier and supported on the bottom of the septic tank. Additionally, or alternatively, brackets can be attached to the top of the clarifier so that the clarifier is supported from the septic tank lid or from the septic tank walls.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. An apparatus for converting a septic tank into an aerobic treatment system for treating liquor containing biodegradable waste, the septic tank having an opening at a top thereof, the septic tank having a wastewater inlet pipe and an effluent outlet pipe, the apparatus comprising:
a clarifier having a collapsible or flexible wall which allows said clarifier to fold or compress in order to pass through the opening of the septic tank and to unfold upon entry into the septic tank, said clarifier having an opening at a top thereof and an opening at a bottom thereof, said opening at the bottom having a diameter no greater than a diameter at the opening at the top of said clarifier;
an aerator having a size suitable for passing through the opening of the septic tank, said aerator adapted to be positioned between the wall of said clarifier and a wall of the septic tank; and
an air pump connected to said aerator so as to pass air to said aerator.

2. The apparatus of claim 1, said clarifier having an aperture formed in the wall thereof, said aperture receiving the effluent outlet pipe therein such that the effluent outlet pipe opens to an interior of said clarifier.

3. The apparatus of claim 1, the wall of said clarifier being spaced from an end of said wastewater inlet pipe.

4. The apparatus of claim 1, the liquor in the septic tank having a top surface, said clarifier positionable such that the top of said clarifier resides above the top surface of the liquor, the bottom of the clarifier being positionable below the top surface of the liquor.

5. The apparatus of claim 4, said clarifier having at least one float connected thereto, the float causing the clarifier to float in the liquor within the septic tank.

6. The apparatus of claim 5, said at least one float comprising a plurality of floats arranged in spaced relationship around said clarifier.

7. The present claim 5, the float being affixed to the wall of said clarifier such that a portion of the float is exposed at an inner wall of said clarifier.

8. The apparatus of claim 1, said clarifier having a truncated conical configuration.

9. The apparatus of claim 1, said aerator comprising:
a ceramic diffuser;
a tube connected to said ceramic diffuser and to said air pump; and
an anchor connected to said ceramic diffuser.

10. The apparatus of claim 9, said tube being flexible so as to extend through the opening of the septic tank, said air pump positioned exterior of the septic tank away from said clarifier.

11. A wastewater treatment system comprising:
a septic tank having an opening at the top thereof, said septic tank having an interior volume surrounded by a wall, said septic tank having a wastewater inlet pipe and an effluent outlet pipe;
a clarifier having a compressible or flexible wall which allows said clarifier to fold or compress to pass through the opening of said septic tank and to unfold or decompress upon entry into said septic tank, said clarifier having an opening at the top thereof and an opening at a bottom thereof, said opening at the bottom having a diameter no greater than a diameter of the opening at the top of said clarifier;
an aerator having a size suitable for passing through the opening of said septic tank, said aerator adaptable to be positioned between the wall of said clarifier and the wall of said septic tank; and
an air pump connected to said aerator so as to pass air to said aerator.

12. The wastewater treatment system of claim 11, said clarifier having an aperture formed in the wall thereof, said aperture receiving the effluent outlet pipe therein such that the effluent outlet pipe opens to an interior of said clarifier.

13. The wastewater treatment system of claim 11, the wall of said clarifier being spaced from an end of said wastewater inlet pipe.

14. The wastewater treatment system of claim 11, said septic tank having a liquor therein, the liquor having a top surface within said septic tank, said clarifier positioned such that the top of said clarifier resides above the top surface of the liquor, the bottom of said clarifier being positioned below the top surface of the liquor.

15. The wastewater treatment system of claim 14, said clarifier having at least one float connected thereto, the float causing said clarifier to float in the liquor of said septic tank.

16. The wastewater treatment system of claim 15, said at least one float comprising a plurality of floats arranged in spaced relationship around said clarifier.

17. The wastewater treatment system of claim 11, said clarifier having a truncated conical configuration.

18. The wastewater treatment system of claim 11, said aerator comprising:
a ceramic diffuser;
a tube connected to said ceramic diffuser and to said air pump; and
an anchor connected to said ceramic diffuser.

19. The wastewater treatment system of claim 18, said tubing being flexible so as to extend through said opening of said septic tank, said air pump positioned exterior of said septic tank away from said clarifier.

20. The wastewater treatment system of claim 11, said septic tank having a bottom, said aerator positioned at the bottom of said septic tank, the bottom of said clarifier being spaced above the bottom of said septic tank.
